(19) United States
(12) Patent Application Publication
(10) Pub. No.: US 2018/0083469 A1
(43) Pub. Date: Mar. 22, 2018

(54) HIGH POWER DENSITY JUMP STARTER

(71) Applicant: SlipStream Projects LLC, Granger, IN (US)

(72) Inventors: Peter Bauer, South Bend, IN (US); Kevin O'Keeffe, South Bend, IN (US)

(73) Assignee: SlipStream Projects LLC, Granger, IN (US)

(21) Appl. No.: 15/710,959

(22) Filed: Sep. 21, 2017

Related U.S. Application Data
(60) Provisional application No. 62/397,755, filed on Sep. 21, 2016.

(51) Int. Cl. H02J 7/00; F02N 19/00

(52) U.S. Cl. CPC H02J 7/0054; F02N 11/0862; F02N 19/001

(57) ABSTRACT

An electrical power assist system to provide supplemental power to assist a starting battery in supplying power to an engine starting motor. The system includes an ultracapacitor assembly, a source battery and a controller circuit. The ultracapacitor assembly is electrically connectable to the starting battery and/or the starting motor. The controller circuit controllably charges the ultracapacitor assembly from the source battery.

### CROSS REFERENCE TO RELATED APPLICATIONS

This is a non-provisional application based upon U.S. provisional patent application Ser. No. 62/397,755, entitled “A HIGH POWER DENSITY JUMP STARTER”, filed Sep. 21, 2016, which is incorporated herein by reference.

### BACKGROUND OF THE INVENTION

### 1. Field of the Invention

The present invention relates to battery assist systems, and, more particularly, to systems for the jump starting of, or the supplying of supplemental power to, an electrical system associated with an engine.

### 2. Description of the Related Art

A jump start of a vehicle, also called a boost, is a method of starting a vehicle with a discharged starting battery. Typically, a temporary connection is made to the battery of another vehicle, or to some other external power source that operates at the same voltage as the discharged starting battery was supposed to supply to the vehicle. The supply of direct current (DC) at a working voltage (often approximately 12 volts) recharges the disabled vehicle's battery and provides some of the power needed to crank the engine. Once the vehicle has been started, its normal charging system will recharge the discharged battery, so the auxiliary source can be removed.

Jump starters are available in the form of portable battery devices, which allow for connection to, and the jump starting of, vehicles. These devices provide electrical power to the electrical system of the disabled vehicle, without the need of the additional vehicle to provide the power to boost the dead vehicle battery. Jump starters come in various sizes and typically carry an Amp rating that relates to the maximum current in Amps that they may provide. Some jump-starters use lithium-ion batteries, often using a high discharge lithium polymer or lithium-ion battery, but many jump-starters still use lead acid batteries.

Starting internal combustion engines when the battery is dead or weak can be difficult. This problem is especially critical in cold weather and/or in large Diesel engines, that are often hard to start during cold weather. This is due to a combination of effects, ranging from slower chemical reactions in the battery and higher viscosity of the engine oil to a higher minimum cranking speed necessary to create hot compressed air in the cylinders for a successful start-up, by way of autoignition. There are also other factors at work that are all related to low temperatures and difficulties in starting an engine, the problems are particularly acute for those with fleets of vehicles, resulting in costly delays and repairs.

The jump starters that are currently available suffer from a variety of problems: bad low temperature performance, high weight, limited crank current, short longevity of the device, and low power density.

What is needed in the art is a jump starter system that is durable, economic to manufacture and does not suffer from the problems delineated above.

### SUMMARY OF THE INVENTION

The present invention provides a jump starting system that can be easily coupled to a vehicle starting system.

The invention in one form is directed to an electrical power assist system to provide supplemental power to assist a starting battery in supplying power to an engine starting motor. The system includes an ultracapacitor assembly, a source battery and a controller circuit. The ultracapacitor assembly is electrically connectable to the starting battery and/or the starting motor. The controller circuit controllably charges the ultracapacitor assembly from the source battery.

The invention in another form is directed to a jump start system to provide supplemental power to assist a starting battery in supplying power to an engine starting motor. The system includes an ultracapacitor assembly, a source battery and a controller circuit. The ultracapacitor assembly is electrically connectable to the starting battery and/or the starting motor. The controller circuit controllably charges the ultracapacitor assembly from the source battery.

The invention in another form is directed to a method of jump starting an engine including the steps of coupling, charging, stopping and engaging. The coupling step is the coupling of an ultracapacitor assembly to a starting battery. The charging step is the charging of the ultracapacitor assembly from a source battery that has a voltage rating that is approximately twice the voltage of the starting battery. The stopping step is the stopping of the charging of the ultracapacitor assembly from the source battery when a controller circuit detects that a voltage across the ultracapacitor assembly is above a predetermined value. The engaging step is the engaging of a starting motor of the engine.

An advantage of the present invention is that a light weight system can be used to jump start a vehicle.

Another advantage is that the voltage control circuit allows the system to draw maximum power from a source that has approximately twice the voltage of the vehicle system.

Yet another advantage of the present invention is that it also allows for adjusting the jump starter output voltage to between 12V and 16V (for a 12V vehicle electrical system) to achieve higher cranking speeds in the case of a 12V vehicle system.

Still yet another advantage is that the jump starter invention has the capability of protecting the vehicle battery during cold starts prophylactically, thus increasing longevity of vehicle batteries.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates in circuit schematical form an embodiment of a jump starting system of the present invention;

FIG. 2 illustrates further details of the controller circuit used in the jump starting system of FIG. 1;

FIG. 3 illustrates the power delivery of the present invention as compared to the prior art; and

FIG. 4 illustrates another embodiment of the present invention in the form of a permanently installed electrical assist system.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

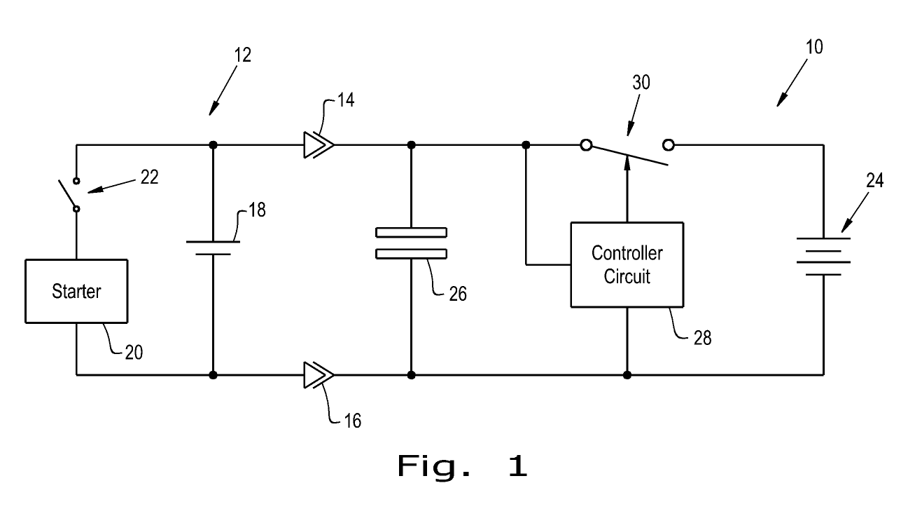

Referring now to the drawings, and more particularly to FIG. 1, where there is shown an embodiment of a high power density jump starter 10 of the present invention, which can be considered to be an electrical power assist system 10. Electrical power assist system 10 provides supplemental power to an engine starting system 12 which can be in a vehicle. Electrical power assist system 10 is coupled to engine starting system 12 by way of electrical connectors 14 and 16. Engine starting system 12 includes a starting battery 18, a starting motor 20, and a switch 22 (which may be a solenoid and relay).

Electrical power assist system 10 assists starting battery 18 in supplying power to engine starting motor 20 for the starting of the engine (not shown). Electrical power assist system 10 includes a source battery 24, an ultracapacitor assembly 26, a controller circuit 28 and a relay 30 under the control of controller circuit 28. Electrical power assist system 10 is electrically connectable to the starting battery 18 and/or the starting motor 20. Controller circuit 28 controllably charges ultracapacitor assembly 26 from source battery 24.

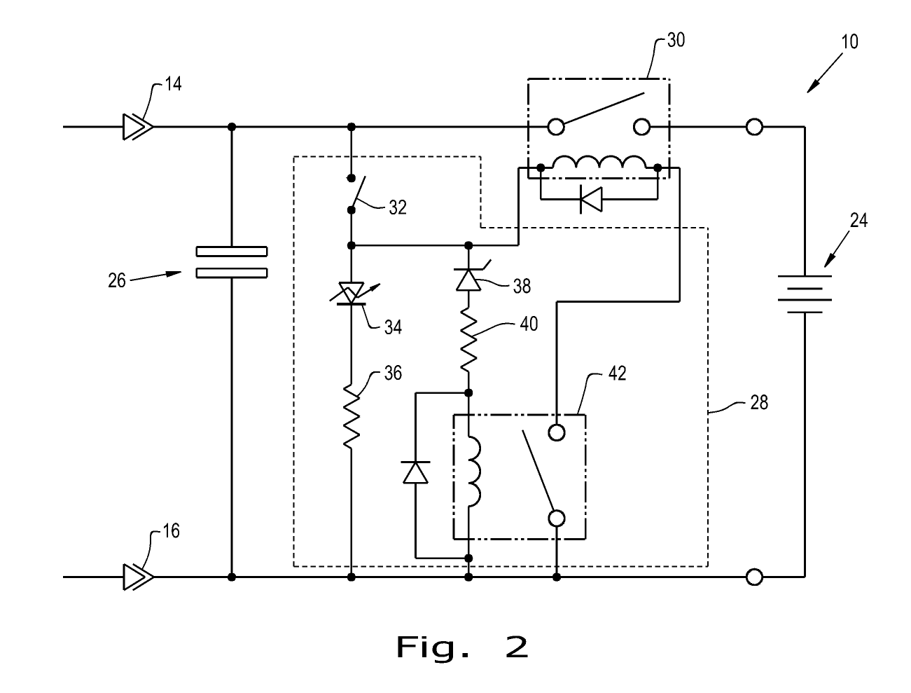

Now additionally referring to FIG. 2, details of an embodiment of controller circuit 28 are illustrated. Here controller circuit 28 includes a switch 32, an LED diode 34, a resistor 36, a Zener diode 38, a resistor 40 and a relay 42. Switch 32 engages controller circuit 28 and provides power to LED 34 to illuminate to indicate that the circuit is active. Zener 38 establishes the voltage at which to engage relay 30 so that battery 24 supplies a charging current to ultracapacitor assembly 26. Once the voltage across ultracapacitor assembly 26 rises to the level that the current through the coil of relay 42 diminishes then relay 30 will open to thereby regulate the power coming from battery 24. Battery 24 has a higher voltage rating than battery 18, and may in particular have twice the voltage rating of battery 18. The capacity of ultracapacitor assembly 26 and the control of controller circuit 28 allows for the coupling of battery 24, which has a higher voltage rating, for controlled amounts of time so that ultracapacitor assembly 26 will be capable of supplying a needed surge of power when starter 20 is engaged.

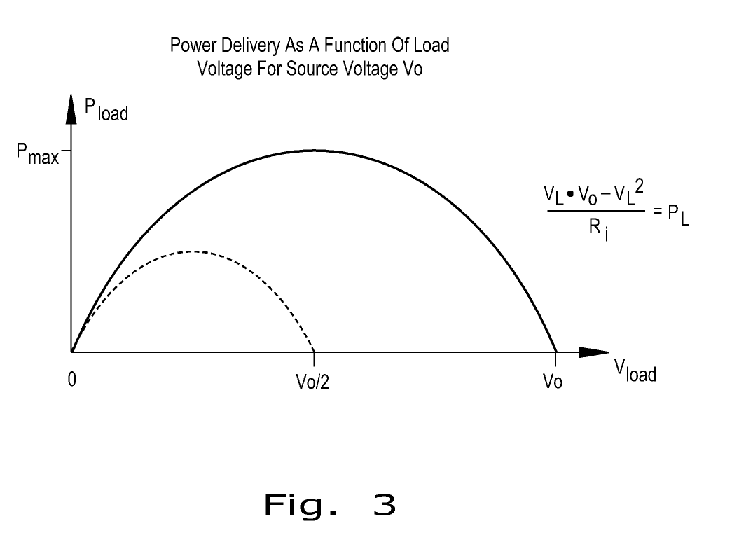

Now additionally viewing FIG. 3, there is illustrated the electrical power that is deliverable to a load, such as starter 20, from the inventive system (solid line) and that available from an unmodified system (dashed line). This illustration graphically displays the advantage of the present invention over the prior art.

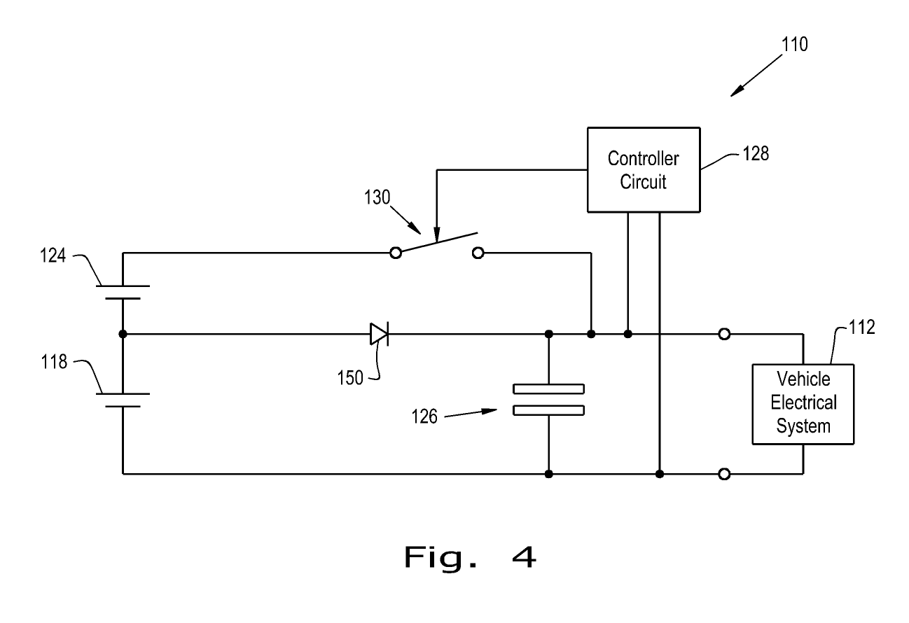

Now, additionally viewing FIG. 4, there is illustrated another embodiment of the present invention in the form of an electrical power assist system 110 that assists starting battery 118 in supplying power to vehicle electrical system 112. Electrical power assist system 110 includes a source battery 124, an ultracapacitor assembly 126, a controller circuit 128 and a relay 130 under the control of controller circuit 128. Controller circuit 128 controllably charges ultracapacitor assembly 126 from source battery 124. Elements of this embodiment that are similar to those of the previous embodiments have 100 added to their reference numbers. Here source battery 124 may be that same or similar voltage rating of battery 118. This embodiment illustrates a permanently installed system where ultracapacitor assembly 126 is charged under the control of controller circuit 128 as needed, primarily from source battery 124 and battery 118. An isolation diode 150 prevents ultracapacitor assembly 126 from back charging battery 118 and ensures that if a malfunction of the relay, control circuit or battery 124 occurs, that the system will still function as a conventional battery-ultracapacitor parallel combination. Both batteries 118 and 124 are charged using conventional methods, which are not shown for the sake of clarity.

The inventive solution of the present invention lies in the combination of ultracapacitors 26, 126, batteries 18, 24, 118, 124 and a voltage control circuit 28, 128 that maximizes cranking amps while keeping unit weight low. Also the system 10, 110 allows for rapid recharge and works well in cold weather. It also makes sure the cranking rpms are high due to providing an elevated voltage at the starter motor 20, which is especially important for starting Diesel engines in cold weather. System 10, 110 also reduces the stress on vehicle batteries 18, 118, thus avoiding deep discharges that cause lifetime reductions of battery 18, 118, leading to premature battery failure.

The claimed invention differs from what currently exists. Prior art systems use either batteries or ultra-capacitors and operate near the vehicle system voltage. Such systems suffer from high weight, low power density, bad performance in cold temperatures, and a need to be plugged in most of the time. In another prior art system the engine crank time is low because of the limited energy density of the ultracapacitors. None of the available prior art systems protect vehicle batteries from low states of charge. The present invention solves all the above problems by exploiting the maximum power transfer theorem, which states that if the load voltage is half of the source voltage, maximum power is delivered to the load. The exact relationship between transferred power and load voltage as a fraction of source voltage is shown in FIG. 3. Therefore, using a 24 Volt (48 Volt) source battery 24 for starting a 12V (24V) system and controlling the load voltage with a controller circuit 28 results in maximum power flow. This advantageously allows for light compact designs and high power densities. While there are a couple of battery—ultra-capacitor systems on the market, none use the controlled double voltage approach of the present invention and none protect the vehicle battery from deep discharge.

Currently available prior art systems do not work well for large Diesel engines, especially under very cold temperatures. Also the lifetime of battery based units is usually 2-4 years. Practically all jump starters for large Diesel engines are extremely heavy (60-200 pounds) and awkward to use. The primary reason for this limited performance is the fact that the source voltage of the jump starting device is the same as the vehicle system voltage, thus limiting the currents that can be delivered as seen in FIG. 3.

The embodiments of the present invention illustrate a voltage control circuit 28, 128 that allows the system to draw power from a source 24, 124 that has twice the voltage of the vehicle system 12, 112. It also allows for adjusting the jump starter output voltage to between 12V and 16V in the case of a 12V vehicle system.

The present invention can be exemplified as—a modular jump starter 10, where the ultracapacitors can be disconnected from the remaining system and used as a jump starter by itself, together with a voltmeter and jumper cables and clamps. The present invention also provides for a jump starter 10 for any ICE engine of any voltage, including 6V, 12V, 24V, 36V and 48 V systems. It is also contemplated to use an Inverter source voltage controller in a DC to AC inverter system, where the DC voltage at the input needs to be stabilized within an acceptable interval. Further, it is contemplated that a system 110 can be part of a permanent installation in Diesel engine systems.

In the present embodiments ultracapacitor assembly 26, 126 is a cascade of ultracapacitors (typically 5 or 6 for a 12V system). Ultracapacitor assembly 26, 126 can also be a parallel assembly of several ultracapacitor cascades. Battery 24 is a 24 V battery or two 12 V batteries (for a 12V system) with a connection to an external charger (not shown for the purpose of clarity). Control circuit 28, 128 is in control of power relay 30, 130 that controls current flow into ultracapacitors 26, 126 from battery 24, 124.

The ultracapacitor bank 26, 126 is connected to the external battery 24, 124 through control circuit 28, 128. Control circuit 28, 128 senses the voltage of ultracapacitor assembly 26, 126 and connects battery 24, 124 (and in series 118) to ultracapacitor assembly 26, 126 if the voltage is below the minimal threshold. Control circuit 28, 128 disconnects ultracapacitor assembly 26, 126 from battery 24, 124 if the voltage of ultracapacitor assembly 26, 126 is above the disconnect threshold. Essentially Control circuit 28, 128 acts as an “electric valve”, i.e. a relay, that opens and closes depending on the voltage level in ultracapacitor assembly 26. This way it is assured that the voltage in ultracapacitor assembly 26, 126 is always between the minimum and maximum threshold. The external battery 24, 124 maybe recharged through an external charger.

Battery 24 is the power source that has twice the voltage of the vehicle electrical system, or in the case of battery 124 it adds voltage to battery 118, so that control circuit 28, 128 is operating at twice the voltage of battery 118. The voltage of ultracapacitor assembly 26, 126 is near the vehicle electrical system 12, 112 voltage or slightly above. Power flows from battery 24, 124 to ultracapacitor assembly 26, 126 through power relay 30, 130 that is controlled by the voltage in ultracapacitor assembly 26, 126. If the voltage in ultracapacitor assembly 26, 126 exceeds the upper threshold (typically around 14-15V in a 12 V system, as determined by Zener diode 38 in the first embodiment) then relay 30, 130 disconnects ultracapacitor assembly 26, 126 from battery 24, 124 and ultracapacitor assembly 26, 126 alone powers starter motor 20 together with the recipient vehicle's own battery 18. If the voltage in ultracapacitor assembly 26, 126 is below the critical threshold (typically around 12V-13V in a 12 V system) then power relay 30, 130 reconnects battery 24, 124 (with battery 118 in series) to ultracapacitor assembly 26, 126, restarting the power flow into the ultra-capacitors 26, 126. This has the secondary effect of protecting vehicle battery 18 from a low state of charge and thus the present invention can be used for protecting batteries against low states of charge, even if the recipient vehicle battery 18, 118 is in good shape and does not require a jump start. Typical wet 12V batteries start to contribute current to the load only if load voltages are below 12.6 V. Thus by keeping the lower voltage threshold above 12.6V, vehicle battery 18 does not even contribute to the starting current as long as this threshold is not crossed.

The present invention requires an ultra-capacitor bank 26, 126 that can handle the maximum allowable electrical system voltage of the vehicle to be started. Power relay 30, 130 (mechanical or electronic) is robust enough that it can handle the current from the external batteries 24, 124 to the ultracapacitors 26, 126. In this embodiment, the batteries and the ultra-capacitor bank are connected together, for example using high quality cable (of at least AWG 4), preferably through a quick connect plug. This connection can also be made via regular jumper cables or any other power connection. Voltage sensing circuit 28, 128 senses the voltage of the ultracapacitors 26, 126 and activates relay 30, 130 (mechanical or solid state) if the lower threshold voltage is crossed, and it disconnects it when the upper threshold voltage is crossed. Control circuit 28, 128 may be constructed in many different ways, using only mechanical relays, only solid state relays, a mix of the two, or even continuous regulation of the power flow thorough IGBTs or power transistors. One possible embodiment of control circuit 28, 128 (basic circuit realization) is illustrated in FIG. 2.

It is also contemplated that an indicator (such as an acoustic alarm or volt meter) to alert users on the charge condition of ultracapacitor bank 26, 126 would add functionality. Power relays can be substituted by electronic devices such as power transistors or IGBTs. Also the controller 28, 128 can be made using a processor that then regulates the power flow depending on recipient vehicle battery voltage trajectory and history.

According to one embodiment of the present teachings, the following steps are performed:

(i) The user connects the jumper cables 14, 16 that are attached to ultracapacitor assembly 26, 126 and connects it to the vehicle battery. (This can be done after the vehicle had problems starting on its own or prophylactically to protect the battery in extremely cold or even hot weather.)

(ii) The user then cranks the engine or waits until glow plugs or manifold heater are ready and then cranks the engine.

(iii) Once the engine started, the user removes the jumper cable clamps 14, 16 from the vehicle battery. If the engine did not start, wait a few seconds, and repeat (ii).

(iv) The unit 10 would then be plugged into a wall outlet to recharge battery 24 using a 24V AC/DC adapter or any other charging device.

Additionally:
The system 10 may be used as a battery protection system in cold weather: The jump starter may be used during the first cold start of a vehicle, i.e. prophylactically protecting the batteries from a deep discharge, even if the engine is expected to start. This avoids premature battery failure and replacement.
The system 10 can be used in a modular form, i.e. by disconnecting the ultra-capacitors from the remaining system and using the ultra-capacitors in combination with the jumper cables, clamps and voltmeter as a separate jump starter that can be recharged by the embodiment or from the recipient vehicle system battery with or without the engine running.
The system 110 can be used as a permanent installation in large Diesel engines and vehicles to achieve better cranking performance, as illustrate in FIG. 4. In this case the alternator could be a 24V alternator or a 12 V alternator. If a 12 V alternator is used a DC/DC converter is needed to charge the second 12V battery to achieve 24V source voltage.
Usage in any device that needs to control a DC voltage within a certain threshold, e.g. for hybrid DC gensets, where the input to the inverter needs to be between a minimum and maximum threshold. In this case the DC to AC converter would have this device at its front end to make sure the allowable DC input voltage range is maintained. The source can be another DC source at a higher voltage, or the output of a rectifier bank rectifying AC voltage of a generator.

There are three basic ways to charge the ultracapacitor bank 26 of the invention: (a) through the double voltage source, i.e. an external battery 24 using the voltage control circuits described in FIGS. 1 and 2. This is the fastest method of power transfer and typically takes a few seconds depending on the battery. (b) through connecting the clamps 14, 16 to the batteries of a running vehicle which will asymptotically produce a voltage of typically between 14V and 14.5V. This typically takes a few seconds, i.e typically 8-30 seconds depending on alternator and vehicle battery. (c) through a specially designed wall outlet power charger that can handle large voltage mismatches between ultracapacitor bank and charger open voltage. This is done using a regular AC/DC converter followed by a power resistor and power diode and is used typically if the ultracapacitor is used as a standalone module, as in being disconnected from battery 24. The power resistor limits the currents in case the ultracapacitor voltage is very low, while the power diode makes sure there is no leakage from the capacitors to the charger if the capacitors are fully charged. This type of charging typically takes on the order of one hour.

Minimizing heat generation at clamp contacts is also contemplated. Due to the high power and current flow from the batteries to the ultracapacitor bank 26, the jump starter system 10 can maintain large currents over long periods of time. This can lead to hot clamp contacts, since the clamp contact can produce a significant resistance depending on a geometry of the contacts, cleanliness of the contacts, etc. This can be avoided by using an auxiliary snap-on clamp on the positive and negative side, which in one embodiment can be attached via an Anderson connector on the pos. and neg. side. This provides an additional current path, thus reducing the power dissipated at any individual contact. Practically all large Diesel vehicles have at least 3 or 4 batteries (and therefore 3 or 4 plus and minus poles) connected in parallel, hence making connectivity a simple task.

Reduction of sparking when connecting is also a consideration. An additional feature is the use of Anderson connectors in the power circuit to reduce sparking in case there is a large mismatch of battery and ultracapacitor 26 voltage. In this case the clamps 14, 16 would be connected BEFORE the Anderson connector completes the circuit for jumpstarting.

Relative to the embodiment illustrated in FIG. 2, relay 42 is “normally closed”, and, when the voltage is higher than a threshold the current through the coil is sufficient that relay 42 opens. Relay 30 is “normally open”, and closes only if relay 42 is closed.

Regarding FIG. 3, Ri is the combined impedance from source to load, including connecting cables and contacts, i.e. the internal resistance from the source battery 24, the internal resistance of the load ultracapacitor bank 26, and the wires connecting the two.

Regarding the embodiment illustrated in FIG. 4, it is shown that system 110, where all electrical loads including the starter connects directly to the ultracapacitors 126, other embodiments are also contemplated. For example, the ultracapacitor bank 126 can be reserved solely for starting the vehicle and use the regular battery 118 (which is connected to the alternator) to power all other electrical loads. The auxiliary battery 124 would be charged through an isolated DC/DC converter feeding from the regular battery 118. The advantage of this option is that one does not need to power the voltage controller circuit 128 when the ignition is switched off and the vehicle electrical system does not see significant voltage fluctuations.

Yet another embodiment is contemplated that is a system where a 24V alternator connects to a 24V battery (or two cascaded 12V batteries) that then connects via the power relay to the ultracapacitor bank which connects to the starter. All other electrical load users would then be powered by a 24V to 12V DC to DC that is powered from the 24V battery.

Alternator connectivity: FIG. 4 does not show the connection of the system to the alternator of the vehicle, for the sake of clarity. There are different options contemplated on how to charge the battery 118 and battery 124, one of the most simple solutions is to charge the regular battery 118 directly from the alternator and use an isolated DC/DC converter to charge battery 124. The DC/DC converter would then be connected on the input to the regular battery and the isolated output to battery 124. Other options include changing the role of the regular and auxiliary battery or using a 24V alternator.

In contrast to all other ultracapacitor plus battery starter systems, the present invention allows the power flow to be so large that the operator can crank the engine while relay 30 is closed and the ultracapacitor voltage is either maintained or even increases as the cranking takes place. All prior art systems use the battery only to recharge the capacitors, and crank once the capacitors are full with the charging batteries being disconnected.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An electrical power assist system to provide supplemental power to assist a starting battery in supplying power to an engine starting motor, the system comprising:
an ultracapacitor assembly being electrically connectable to at least one of the starting battery and the starting motor;
a source battery; and
a controller circuit controllably charging the ultracapacitor assembly from the source battery.

2. The electrical power assist system of claim 1, wherein the source battery is approximately twice the voltage of the starting battery.

3. The electrical power assist system of claim 1, wherein the source battery is approximately the same voltage as the starting battery, the source battery and the starting battery being electrically connected in series.

4. The electrical power assist system of claim 1, wherein the controller circuit disconnects the source battery from the ultracapacitor assembly when the voltage on the ultracapacitor assembly is above a predetermined voltage.

5. The electrical power assist system of claim 4, wherein the predetermined voltage is between 14 and 15 volts.

6. The electrical power assist system of claim 4, wherein the source battery is directly electrically coupled to the ultracapacitor assembly by the controller circuit when the voltage across the ultracapacitor assembly is less than the predetermined voltage.

7. The electrical power assist system of claim 6, further comprising a relay coupled to the source battery, the ultracapacitor assembly and the controller circuit, the relay providing the electrical coupling of the source battery to the ultracapacitor assembly when the voltage across the ultracapacitor assembly is less than the predetermined voltage.

8. The electrical power assist system of claim 1, wherein the ultracapacitor assembly is a plurality of ultracapacitors connected in series or in a parallel-series connection.

9. The electrical power assist system of claim 8, wherein the plurality of ultracapacitors connected in series is at least 5 ultracapacitors.

10. The electrical power assist system of claim 1, further comprising a diode, the ultracapacitor assembly being isolated from the starting battery by the diode.

11. A jump start system to provide supplemental power to assist a starting battery in supplying power to an engine starting motor, the system comprising:
an ultracapacitor assembly being electrically connectable to the starting battery;
a source battery; and
a controller circuit controllably charging the ultracapacitor assembly from the source battery.

12. The jump start system of claim 11, wherein the source battery is approximately twice the voltage of the starting battery.

13. The jump start system of claim 11, wherein the controller circuit disconnects the source battery from the ultracapacitor assembly when the voltage on the ultracapacitor assembly is above a predetermined voltage.

14. The jump start system of claim 13, wherein the predetermined voltage is between 14 and 15 volts.

15. The jump start system of claim 13, wherein the source battery is directly electrically coupled to the ultracapacitor assembly by the controller circuit when the voltage across the ultracapacitor assembly is less than the predetermined voltage.

16. The jump start system of claim 15, further comprising a relay coupled to the source battery, the ultracapacitor assembly and the controller circuit, the relay providing the electrical coupling of the source battery to the ultracapacitor assembly when the voltage across the ultracapacitor assembly is less than the predetermined voltage.

17. The jump start system of claim 11, wherein the ultracapacitor assembly is a plurality of ultracapacitors connected in a series or in a parallel-series connection.

18. The jump start system of claim 17, wherein the plurality of ultracapacitors connected in series is at least 5 ultracapacitors.

19. A method of jump starting an engine, comprising the steps of:
coupling an ultracapacitor assembly to a starting battery;
charging the ultracapacitor assembly from a source battery that has a voltage rating that is approximately twice the voltage of the starting battery;
stopping the charging of the ultracapacitor assembly from the source battery when a controller circuit detects that a voltage across the ultracapacitor assembly is above a predetermined value; and
engaging a starting motor of the engine.

20. The method of claim 19, wherein the ultracapacitor assembly is a plurality of ultracapacitors connected in a series or in a parallel-series connection.
